(19) United States
(12) Patent Application Publication
(10) Pub. No.: US 2026/0153956 A1
(43) Pub. Date: Jun. 4, 2026

(54) SENSING DEVICE AND DISPLAY DEVICE AND ELECTRONIC DEVICE INCLUDING THE SAME

(71) Applicant: Samsung Display Co., Ltd., Yongin-Si (KR)

(72) Inventors: Jung Ha SON, Yongin-si (KR); Jung Hak KIM, Yongin-si (KR); Yun A MA, Yongin-si (KR); Sang Wook YOO, Yongin-si (KR); Jeong Heon LEE, Yongin-si (KR)

(21) Appl. No.: 19/259,727

(22) Filed: Jul. 3, 2025

(30) Foreign Application Priority Data
Dec. 4, 2024 (KR) 10-2024-0178613

(51) Int. Cl. G06F 3/041; G06F 3/044

(52) U.S. Cl. CPC G06F 3/04164; G06F 3/0412; G06F 3/04166; G06F 3/0446; G06F 3/0443

(57) ABSTRACT

According to embodiments of the disclosure, a sensing device includes sensors arranged in a matrix form in a sensing area. Sensing lines are electrically connected to the sensors, respectively. A first multiplexer is electrically connected between the sensing lines and pads. The sensing area includes a first area and a second area. A first sub-multiplexer of the first multiplexer is electrically connected to the sensors in the first area. A second sub-multiplexer of the first multiplexer is electrically connected to the sensors in the second area. The first sub-multiplexer is disposed on one side of the sensing area and the second sub-multiplexer is disposed on another side of the sensing area.

### CROSS-REFERENCE TO RELATED APPLICATION

The present application claims priority under 35 U.S.C. § 119(a) to Korean Patent Application No. 10-2024-0178613, filed on Dec. 4, 2024, in the Korean Intellectual Property Office, the entire disclosure of which is incorporated herein by reference.

### BACKGROUND

### 1. Technical Field

Embodiments of the present disclosure relate to a sensing device and a display device and an electronic device including the same.

### 2. Related Art

With increasing interest in information displays in recent years, demands for display devices for displaying images are increasing in various forms. In addition, research and development on display devices including touch sensors are being conducted to ensure user convenience and further expand the application field.

### SUMMARY

An object of this disclosure is to provide a sensing device capable of minimizing a border (or a dead space, a non-sensing area), and a display device and an electronic device including the sensing device.

However, the subject matter of this disclosure is not necessarily limited to the above and other technical subject matter not mentioned will be clearly understood by those skilled in the art from the following description.

A sensing device according to embodiments of the present disclosure includes sensors arranged in a matrix form in a sensing area; sensing lines electrically connected to the sensors, respectively; and a first multiplexer electrically connected between the sensing lines and pads, wherein the sensing area includes a first area and a second area, wherein the first multiplexer includes: a first sub-multiplexer electrically connected to the sensors in the first area; and a second sub-multiplexer electrically connected to the sensors in the second area, and wherein the first sub-multiplexer is disposed on one side of the sensing area and the second sub-multiplexer is disposed on another side of the sensing area.

In an embodiment, the first sub-multiplexer and the second sub-multiplexer may be spaced apart from each other in a first direction with the sensing area interposed therebetween, and the first area and the second area may be arranged along a second direction intersecting the first direction.

In an embodiment, the first sub-multiplexer may be disposed on the one side of the first area but not on one side of the second area, and the second sub-multiplexer may be disposed on another side of the second area but not on another side the first area.

In an embodiment, the sensing device may further include a second multiplexer electrically connected between the first multiplexer and the pads, wherein the second multiplexer and the pads may be arranged along the second direction from the sensing area.

In an embodiment, the first multiplexer may include a first transistor electrically connected between one of the sensing lines and a first driving line; and a second transistor electrically connected between the one sensing line and a connection line, and the second multiplexer may include a third transistor electrically connected between the connection line and one of the pads; and a fourth transistor electrically connected between the connection line and a second driving line.

In an embodiment, a target pulse signal may be applied to the one pad, a first driving signal having a phase opposite to the target pulse signal may be applied to the first driving line, and a second driving signal having the same phase as the target pulse signal may be applied to the second driving line.

In an embodiment, with respect to the sensors disposed in one column, the second multiplexer may electrically connect a first sensor of the sensors to one of the pads and a second sensor adjacent to the first sensor to the second driving line, and the first multiplexer may electrically connect a third sensor of the sensors except for the first sensor and the second sensor to the first driving line.

In an embodiment, the sensing device may further include a plurality of first driving lines respectively and electrically connected to the sensors arranged in one column through the first multiplexer, wherein the plurality of first driving lines include the first driving line, wherein a portion of the plurality of first driving lines are disposed on the one side of the sensing area and are electrically connected to the first sub-multiplexer, and wherein a remaining portion of the plurality of first driving lines are disposed on the other side of the sensing area and are electrically connected to the second sub-multiplexer.

In an embodiment, with respect to the sensors disposed in one column, a number of the portion of the plurality of first driving lines may be equal to a number of the sensors arranged in the second direction in the first area, and a number of the remaining portion of the plurality of first driving lines may be equal to a number of the sensors arranged in the second direction in the second area.

In an embodiment, the plurality of first driving lines may extend in the second direction in an area in which the first multiplexer is disposed.

In an embodiment, the second driving line may extend in the second direction in an area in which the second multiplexer is disposed.

In an embodiment, the second driving line may extend in the first direction in an area in which the second multiplexer is disposed.

In an embodiment, the first multiplexer may selectively couple the sensors disposed in two columns to one of the pads.

In an embodiment, the first sub-multiplexer and the second sub-multiplexer may be spaced apart from each other in a first direction with the sensing area interposed therebetween, and the first area and the second area may be arranged along the first direction.

A display device according to embodiments of the present disclosure includes a display unit including a base layer and a light-emitting element disposed on the base layer; a sensing unit disposed on the display unit and including sensors arranged in a matrix form in a sensing area and sensing lines electrically connected to the sensors, respectively; and a first multiplexer electrically connected to the sensing lines, wherein the sensing area includes a first area and a second area, wherein the first multiplexer includes: a first sub-multiplexer electrically connected to the sensors in the first area; and a second sub-multiplexer electrically connected to the sensors in the second area, and wherein the first sub-multiplexer is disposed on one side of the sensing area, and the second sub-multiplexer is disposed on another side of the sensing area.

In an embodiment, the first sub-multiplexer and second sub-multiplexer may be spaced apart from each other in a first direction with the sensing area interposed therebetween, and the first area and the second area may be arranged along a second direction intersecting the first direction.

In an embodiment, the display device may further include a second multiplexer electrically connected between the first multiplexer and the pads, wherein the second multiplexer and the pads are located in the second direction from the sensing area.

In an embodiment, the first multiplexer may include a first transistor electrically connected between one of the sensing lines and a first driving line, and a second transistor electrically connected between the one sensing line and a connection line, and the second multiplexer may include a third transistor electrically connected between the connection line and one of the pads, and a fourth transistor electrically connected between the connection line and a second driving line.

In an embodiment, the display unit may include a light-emitting element layer including a light-emitting device and an encapsulation layer disposed on the light-emitting element layer, and wherein the sensing unit is disposed directly on the encapsulation layer.

An electronic device according to embodiments of the present disclosure includes a processor providing input image data; a display device displaying an image based on the input image data; and a power supply supplying power to the display device, wherein the display device includes: a display unit including a base layer and a light-emitting element disposed on the base layer; a sensing unit disposed on the display unit and including sensors arranged in a matrix form in a sensing area and sensing lines electrically connected to the sensors, respectively; and a first multiplexer electrically connected to the sensing lines, wherein the sensing area includes a first area and a second area, wherein the first multiplexer includes a first sub-multiplexer electrically connected to the sensors in the first area, and a second sub-multiplexer electrically connected to the sensors in the second area, and wherein the first sub-multiplexer is disposed on one side of the sensing area and the second sub-multiplexer is disposed on another side of the sensing area.

Further details of the embodiments are contained in the description and drawings.

### BRIEF DESCRIPTION OF THE DRAWINGS

FIG. 1 is a schematic diagram illustrating a display device according to embodiments.

FIG. 2 is a schematic plan view illustrating an embodiment of a display unit included in the display device of FIG. 1.

FIG. 3 is a schematic plan view illustrating an embodiment of a sensing unit included in the display device of FIG. 1.

FIG. 4 is a schematic plan view illustrating an embodiment of the sensing unit of FIG. 3.

FIG. 5 is a schematic cross-sectional view illustrating the display device of FIG. 1.

FIG. 6 is a schematic diagram illustrating an operation in which the display device of FIG. 1 detects a touch input.

FIG. 7 is a schematic circuit diagram illustrating an embodiment of a multiplexer included in the sensing unit of FIG. 4.

FIG. 8 is a plan view illustrating an operation of a sensing device.

FIG. 9 is a waveform diagram illustrating an embodiment of a signal applied to a sensing electrode of FIG. 8.

FIG. 10 is a schematic circuit diagram illustrating an embodiment of the sensing unit of FIG. 4.

FIG. 11 is a plan view illustrating the operation of a sensing unit.

FIGS. 12 and 13 are schematic plan views illustrating an embodiment of the sensing unit of FIG. 4.

FIG. 14 is a schematic plan view illustrating a comparative example of a sensing unit included in a display device.

FIG. 15 is a schematic plan view illustrating an embodiment of the sensing unit included in the display device of FIG. 1.

FIG. 16 is a block diagram of an electronic device according to an embodiment.

FIG. 17 is a schematic diagram of an electronic device according to various embodiments.

### DETAILED DESCRIPTION

The present disclosure may make various modifications and take various forms, and specific embodiments will be illustrated in the drawings and described in detail in the text. It is to be understood, however, that this disclosure is not intended to be limited to the particular form of disclosure, but is to cover all modifications, equivalents, and alternatives falling within the spirit and scope of the disclosure.

The terms first, second, or the like, may be used to describe various components, but the components should not be limited by the terms. The above terms are used only for the purpose of distinguishing one component from another. For example, a first component may be named a second component, and similarly, a second component may also be named a first component, without departing from the scope of the present disclosure. The singular forms “a”, “an” and “the” include plural references unless the context clearly requires otherwise.

Some embodiments are described in the accompanying drawings with respect to functional blocks, units, and/or modules. Those skilled in the art will appreciate that such blocks, units, and/or modules are physically implemented by logic circuitry, discrete components, microprocessors, hard wire circuitry, memory devices, wire connections, and other electronic circuitry. This may be formed using semiconductor-based manufacturing techniques or other manufacturing techniques. In the case of blocks, units and/or modules implemented by microprocessors or other similar hardware, they may be programmed and controlled using software to perform the various functions discussed herein, and optionally driven by firmware and/or software. In addition, each block, unit, and/or module may be implemented by dedicated hardware, or may be implemented by a combination of dedicated hardware performing some functions and a processor (e.g., one or more programmed microprocessors and associated circuitry) performing other functions. In addition, in some embodiments, blocks, units, and/or modules may be physically separated into two or more separate blocks, units, or modules that interact within a scope that does not depart from the scope of the inventive concept. In addition, in some embodiments, blocks, units, and/or modules may be physically combined into more complex blocks, units, or modules without departing from the scope of the present disclosure.

In this disclosure, the terms “comprise” or “have” and the like are intended to designate the presence of a feature, number, step, operation, component, part, or combination thereof described in the specification, and should not be understood to preclude the presence or possibility of addition of one or more other features, numbers, steps, operations, components, parts, or combinations thereof. Also, when a portion of a layer, film, region, plate, etc. is “on” another portion, this includes not only the case where the other portion is “directly on” but also the case where there is another portion in the middle. In addition, in the present specification, when a part such as a layer, a film, a region, or a plate is formed on another part, the formed direction is not limited to the upper direction, but includes a side surface or a lower direction. Conversely, if a part of a layer, film, area, plate, etc. is “below” another part, this includes not only the case where the other part is “right below” but also the case where there is another part in the middle.

Hereinafter, a display device according to an embodiment of the present inventive concept will be described with reference to the drawings related to the embodiments of the present inventive concept.

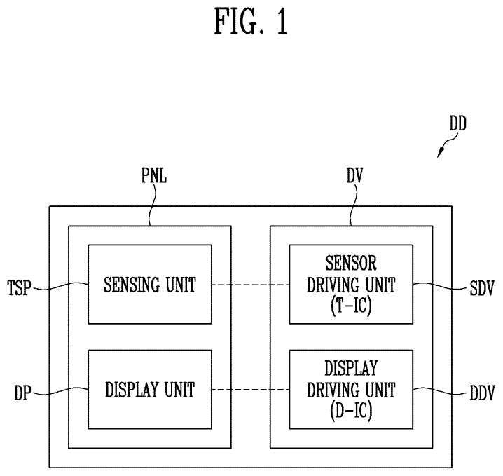

A display device DD according to an embodiment will be described with reference to FIGS. 1 to 5.

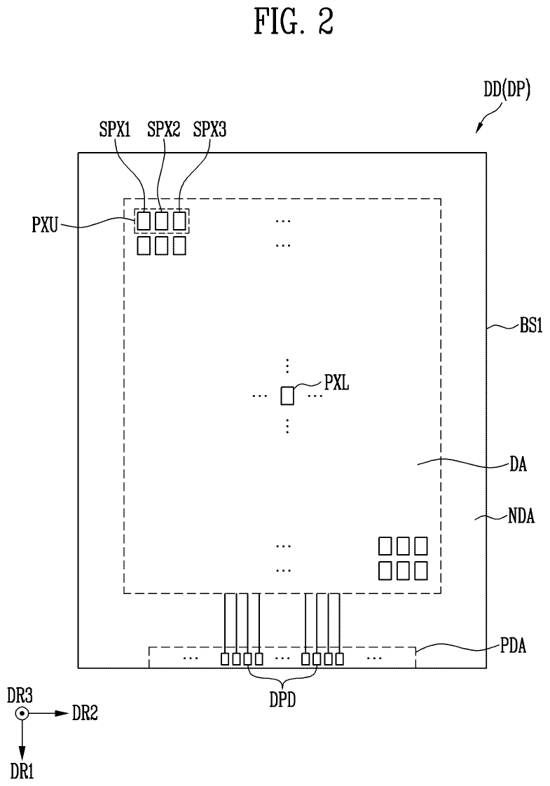

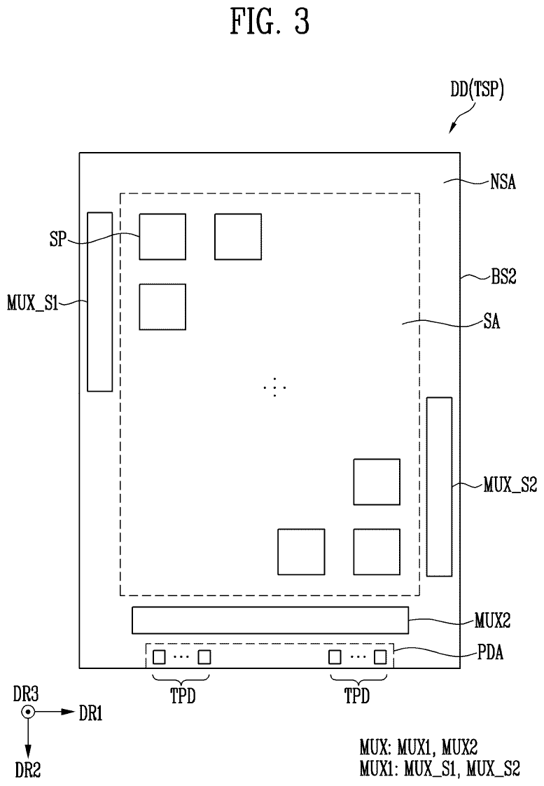

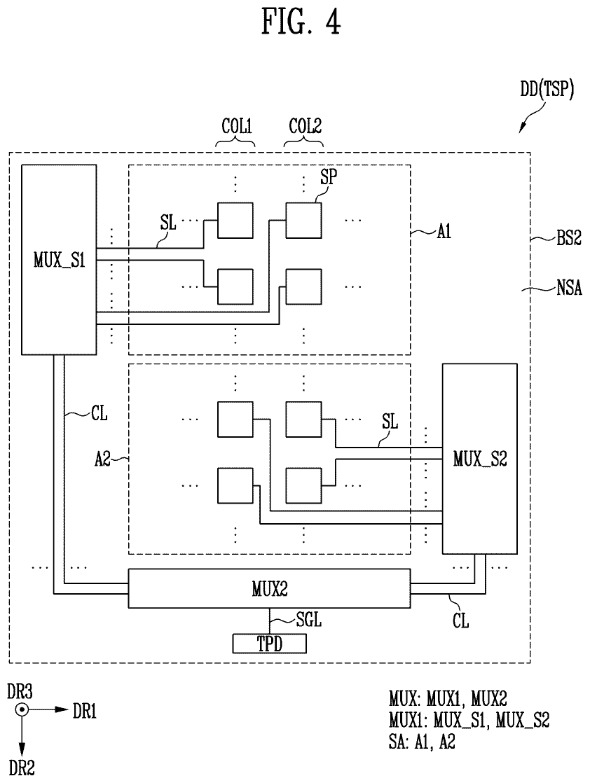

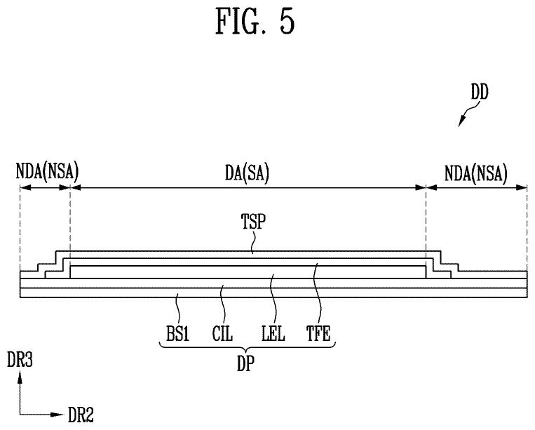

FIG. 1 is a schematic diagram illustrating the display device DD according to embodiments. FIG. 2 is a schematic plan view illustrating an embodiment of a display unit DP included in the display device DD of FIG. 1. FIG. 3 is a schematic plan view illustrating an embodiment of a sensing unit TSP included in the display device DD of FIG. 1. FIG. 4 is a schematic plan view illustrating an embodiment of the sensing unit TSP of FIG. 3. FIG. 5 is a schematic cross-sectional view illustrating the display device DD of FIG. 1.

Referring to FIGS. 1 to 5, the display device DD may provide (or emit) light. According to an embodiment, the display device DD may be used for various devices and the applicable device is not limited to a specific example.

The display device DD may include a panel PNL and a driving circuit unit DV configured to drive the panel PNL.

The panel PNL may include the display unit DP (or display panel) configured to display an image and the sensing unit TSP (or sensing panel) configured to sense a user input (for example, a touch input).

The display unit DP may include pixels PXL. The sensing unit TSP may include sensing electrodes SP (or sensors).

The driving circuit unit DV may include a display driving unit DDV (or display driver, D-IC) configured to drive the display unit DP and a sensor driving unit SDV (or touch driver, T-IC) configured to drive the sensing unit TSP. The sensing unit TSP and the sensor driving unit SDV may form a sensing device.

According to an embodiment, the display unit DP may be referred to as a display layer or a display panel. The sensing unit TSP may be referred to as a sensing layer, a sensor panel, or a touch sensor.

The pixels PXL may display an image in units of a display frame period. The sensing electrodes SP may sense the user's input (for example, the touch input) in units of a sensing frame period. According to an embodiment, the sensing frame period and the display frame period may be independent of each other or may be different from each other. The sensing frame period and the display frame period may be synchronized or asynchronous with each other.

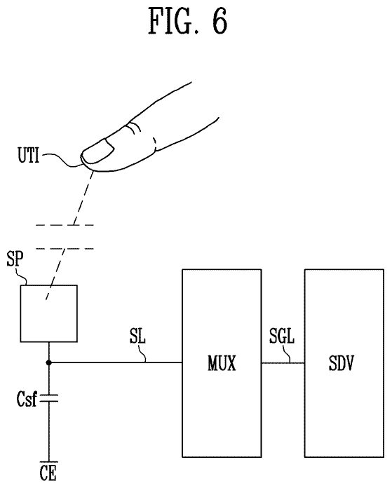

The sensing unit TSP including the sensing electrodes SP may obtain information on user touch input UTI (refer to FIG. 6). The information on touch input (or touch event) may refer to information including the location of the touch that the user wants to provide.

A first base layer BS1 may be a base substrate or a base member for supporting the display device DD. The first base layer BS1 may be a rigid substrate made of glass. Alternatively, the first base layer BS1 may be a flexible substrate. In this case, the base layer may include an insulating material such as a polymer resin such as polyimide. However, the present disclosure is not particularly limited thereto.

The display device DD (or the display unit DP) may include a display area DA and a non-display area NDA. The non-display area NDA may surround at least a portion of the display area DA. The non-display area NDA may be disposed at a periphery of the display area DA.

The pixels PXL, scan lines and data lines electrically connected to the pixels PXL may be disposed in the display area DA.

The pixels PXL may receive data signals from the data lines based on scan signals at a turn-on level supplied from the scan lines, and emit light of luminance corresponding to the data signals. Accordingly, an image corresponding to the data signals is displayed in the display area DA.

The pixels PXL may be arranged according to various arrangement structures in the display area DA. For example, the pixels PXL may be arranged according to a stripe, a PENTILE™ (or normal PENTILE™), or a diamond PENTILE™ arrangement structure. However, the present disclosure is not necessarily limited to the examples described above.

A pixel PXL may include two or more sub-pixels. The two or more sub-pixels may form a single pixel unit PXU capable of emitting light of various colors.

For example, the pixel PXL may include a first sub-pixel SPX1, a second sub-pixel SPX2, and a third sub-pixel SPX3. Each of the first to third sub-pixels SPX1 to SPX3 may emit light of one color. For example, the first sub-pixel SPX1 may be a red pixel that emits red light (for example, a first color), the second sub-pixel SPX2 may be a green pixel that emits green light (for example, a second color), and the third sub-pixel SPX3 may be a blue pixel that emits blue light (for example, a third color).

In another embodiment, the pixel PXL may include four sub-pixels. For example, the pixel PXL may be implemented as an RGBG type pixel unit PXU including one red pixel, one blue pixel, and two green pixels, or may be implemented as a RGBW type pixel unit TXU including one red pixel, one blue pixel, one green pixel, and one white pixel. The number of sub-pixels included in the pixel PXL and the color of light emitted by each sub-pixel are not particularly limited thereto.

In the non-display area NDA, various wires and/or internal circuit units connected to the pixel PXL of the display area DA may be disposed. For example, a plurality of wires for supplying various power and control signals to the display area DA may be disposed in the non-display area NDA.

The sensing unit TSP may obtain information on the input provided by the user. The sensing unit TSP may be configured to recognize the touch input.

The display device DD (or the sensing unit TSP) may include a sensing area SA and a non-sensing area NSA (or a border, a dead space).

In an embodiment, the sensing area SA may be disposed to overlap at least one area of the display area DA. For example, the sensing area SA may be set to an area corresponding to the display area DA (for example, an area overlapping with the display area DA), and the non-sensing area NSA may be set to an area corresponding to the non-display area NDA (for example, an area overlapping with the non-display area NDA). In this case, when the touch input or the like is provided on the display area DA, the touch input may be detected through the sensing unit TSP.

A second base layer BS2 may include one or more insulating layers. For example, an insulating layer (for example, an inorganic insulating layer) for forming the second base layer BS2 may be disposed (for example, directly disposed) on the display unit DP (for example, an encapsulation layer TFE) to form a base for forming the sensing electrodes SP. However, examples for forming the second base layer BS2 are not particularly limited thereto.

The sensing area SA is an area that may be respond to the touch input (for example, an active area of a sensor). To this end, sensing electrodes SP for sensing the touch input or the like may be disposed in the sensing area SA.

The sensing electrodes SP may obtain information on the user touch input using a self-capacitance method.

The sensing electrodes SP may be arranged in various structures in the sensing area SA. For example, the sensing electrodes SP may be arranged in a first direction DR1. The sensing electrodes SP may be arranged in a second direction DR2. The sensing electrodes SP may be arranged in a matrix form defined with respect to the first direction DR1 and the second direction DR2. However, the present disclosure is not limited thereto. For example, the sensing electrodes SP may be arranged in a circular shape, an elliptical shape, or an oblique shape.

In an embodiment, the first direction DR1 and the second direction DR2 may be different directions. The first direction DR1 and the second direction DR2 may be orthogonal to each other. However, the present disclosure is not necessarily limited thereto. For example, the first direction DR1 and the second direction DR2 may extend in oblique directions.

In an embodiment, the sensing electrodes SP may have various shapes. For example, the sensing electrodes SP may have various shapes such as square, triangular, circular, oval, or mesh.

In an embodiment, the sensing electrodes SP may include a conductive material. For example, the sensing electrodes SP may have conductivity by including at least one of a metal material, a transparent conductive material, and various other conductive materials. For example, the sensing electrodes SP may include at least one of a variety of metal materials, including gold (Au), silver (Ag), aluminum (Al), molybdenum (Mo), chromium (Cr), titanium (Ti), nickel (Ni), neodymium (Nd), copper (Cu), platinum (Pt), or an alloy thereof. The sensing electrodes SP may include at least one of a variety of transparent conductive materials, including silver nanowire (AgNW), Indium Tin Oxide (ITO), Indium Zinc Oxide (IZO), Indium Gallium Zinc Oxide (IGZO), Antimony Zinc Oxide (AZO), Indium Tin Zinc Oxide (ITZO), Zinc Oxide (ZnO), Tin Oxide (SnO2), Carbon Nano Tube, or graphene. The sensing electrodes SP may include a single layer or multiple layers, and the cross-sectional structure thereof is not particularly limited.

The panel PNL may include a pad area PDA. The panel PNL may include display pads DPD and a touch sensing pad TPD disposed in the pad area PDA.

The display pads DPD may be electrically connected to the pixels PXL in the display area DA through the wires. The display pads DPD may be electrically connected to the display driving unit DDV formed (for example, included) in the driving circuit unit DV. For example, an electrical signal provided by the display driving unit DDV may be applied to the pixel PXL through the display pads DPD.

The touch sensing pads TPD (or pads) may be electrically connected to the sensing electrodes SP through the wires and a multiplexer MUX. The touch sensing pads TPD may be electrically connected to the sensor driving unit SDV formed (for example, included) in the driving circuit unit DV. For example, an electrical signal provided by the sensor driving unit SDV may be applied to the sensing electrode SP through the touch sensing pads TPD.

The driving circuit unit DV may include a flexible circuit board. The driving circuit unit DV may be implemented as an integrated circuit IC.

The driving circuit unit DV may include the display driving unit DDV and the sensor driving unit SDV. The driving circuit unit DV may be formed on a rear surface of the first base layer BS1.

The display driving unit DDV may be electrically connected to the display unit DP and may be configured to drive the display unit DP. The display driving unit DDV is formed on the rear surface of the first base layer BS1 and may be electrically connected to the pixels PXL through the display pads DPD. The display driving unit DDV may include a data driving unit, a timing control unit, a scan driving unit, or the like.

The sensor driving unit SDV may be electrically connected to the sensing unit TSP, and may be configured to drive the sensing unit TSP. The sensor driving unit SDV may be formed on the back surface of the first base layer BS1, and may be electrically connected to the sensing electrode SP through the touch sensing pad TPD.

Referring to FIG. 4, the sensing unit TSP may further include a sensing line SL (or a sensor line) and a signal line SGL. The sensing lines SL may be electrically connected to the sensing electrodes SP one-to-one. One sensing line SL may electrically connect the sensing electrode SP and the multiplexer MUX in the sensing area SA. The signal line SGL may electrically connect the multiplexer MUX and the touch sensing pad TPD. Accordingly, a driving signal provided by the sensor driving unit SDV may be applied to the sensing electrode SP through the signal line SGL, the multiplexer MUX, and the sensing line SL.

The panel PNL (for example, the sensing unit TSP) may include the multiplexer MUX. The multiplexer MUX is disposed in the non-sensing area NSA, and may be electrically connected between the sensing line SL (or the sensing electrode SP) and the touch sensing pad TPD. The multiplexer MUX may selectively connect the sensing line SL to the touch sensing pad TPD. An electrical signal provided by the touch sensing pad TPD (for example, the driving signal provided by the sensor driving unit SDV) may be applied to the sensing electrode SP via the multiplexer MUX.

The multiplexer MUX may include a first multiplexer MUX1 and a second multiplexer MUX2.

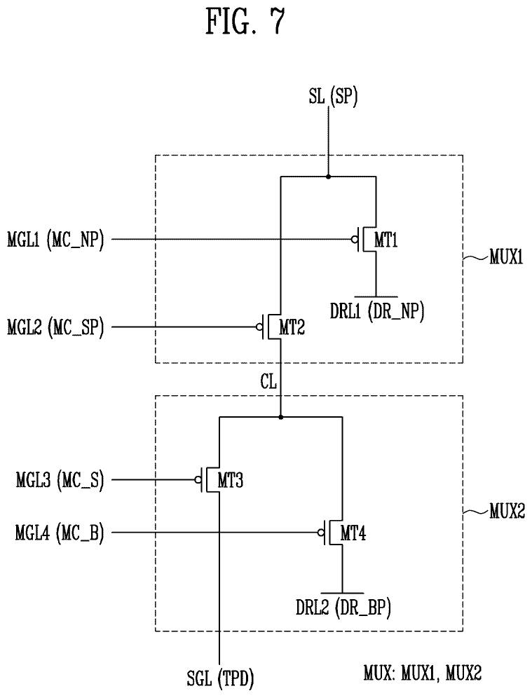

The first multiplexer MUX1 is electrically connected between the sensing line SL and the connection line CL, and the second multiplexer MUX2 may be electrically connected between the connection line CL and the signal line which is connected to the touch sensing pad TPD. The first multiplexer MUX1 and the second multiplexer MUX2 may be interconnected through the connection line CL. The configuration of the first multiplexer MUX1 and the second multiplexer MUX2 will be described later with reference to FIG. 7.

In some embodiments, the first multiplexer MUX1 may include a first sub-multiplexer MUX_S1 and a second sub-multiplexer MUX_S2.

The first sub-multiplexer MUX_S1 may be disposed on one side of the sensing area SA, and the second sub-multiplexer MUX_S2 may be disposed on the other side of the sensing area SA. The first sub-multiplexer MUX_S1 and the second sub-multiplexer MUX_S2 may be spaced apart from each other in the first direction DR1 with the sensing area SA interposed therebetween. For example, as shown in FIG. 4, the first sub-multiplexer MUX_S1 may be disposed on the left side of the sensing area SA and the second sub-multiplexer MUX_S2 may be disposed on the right side of the sensing area SA. In addition, the first sub-multiplexer MUX_S1 and the second sub-multiplexer MUX_S2 may be spaced apart from each other in the second direction DR2. For example, as shown in FIG. 4, with respect to the boundary between a first area A1 and a second area A2, the first sub-multiplexer MUX_S1 may be disposed on an upper side of the boundary and the second sub-multiplexer MUX_S2 may be disposed on a lower side of the boundary. Though the first sub-multiplexer MUX_S1 and the second sub-multiplexer MUX_S2 are illustrated as being spaced apart from each other in the left and right and/or up and down directions, the present inventive concept is not limited thereto.

The second multiplexer MUX2 and the touch sensing pad TPD may be disposed in the second direction DR2 from the sensing area SA, for example, on a lower side of the sensing area SA. As will be described later, since the first sub-multiplexer MUX_S1, the second sub-multiplexer MUX_S2, and the second multiplexer MUX2 are disposed throughout in mutually different directions of the sensing area SA, the width (or average width) of the non-sensing area NSA may be reduced compared to a case where the multiplexer MUX is disposed on the one side of the sensing area SA. For example, the width in the second direction DR2 of the non-sensing area NSA located on the lower side of the sensing area SA may be 5 mm or less (or may be reduced to 5 mm or less). In other words, when the area of the sensing unit TSP is limited, the sensing area SA having a larger width (or length, area) may be provided by the reduced width of the non-sensing area NSA.

The sensing area SA may include the first area A1 and the second area A2 disposed along the second direction DR2, the first sub-multiplexer MUX_S1 may be electrically connected to the sensing electrode SP (or the sensing line SL) in the first area A1 and the second sub-multiplexer MUX_S2 may be electrically connected to the sensing electrode SP (or sensing line SL) in the second area A2. The first sub-multiplexer MUX_S1 may not be connected to or electrically separated from the sensing electrode SP in the second area A2 and the second sub-multiplexer MUX_S2 may not be connected to or electrically separated from the sensing electrode SP in the first area A1.

With respect to a first sensor column COL1 or a second sensor column COL2 including the sensing electrodes SP arranged in the second direction DR2, a portion of the sensing electrodes SP (that is, the sensing electrodes SP located in the first area A1) may be electrically connected to the first sub-multiplexer MUX_S1, and the remaining sensing electrodes SP (that is, the sensing electrodes SP located in the second area A2) may be electrically connected to the second sub-multiplexer MUX_S2. The number of the portion of sensing electrodes SP (or the number of sensing electrodes SP located in the first area A1) and the number of the remaining sensing electrodes SP (or the number of sensing electrode SP located in the second area A2) may be the same, but is not limited thereto.

Since the first sub-multiplexer MUX_S1 is electrically connected to the sensing electrodes SP (or the sensing lines SL) in the first area A1, the first sub-multiplexer MUX_S1 may be disposed on one side (for example, the left side) of the first area A1. The second sub-multiplexer MUX_S2 is electrically connected to the sensing electrode SPs (or the sensing lines SL) in the second area A2, and thus may be disposed on the other side (for example, the right side) of the second area A2. The first sub-multiplexer MUX_S1 may not be disposed on one side of the second area A2 and the second sub-multiplexer MUX_S2 may not be disposed on the other side of the first area A1. However, it is not limited thereto. For example, the first sub-multiplexer MUX_S1 may be disposed on the one side (for example, the left side) of the second area A2 instead of the one side (for example, the left side) of the first area A1.

Referring to FIG. 5, the display unit DP may include a circuit layer CIL, a light-emitting element layer LEL, and the encapsulation layer TFE disposed on the first base layer BS1. A third direction DR3 may be a direction perpendicular to the first direction DR1 and the second direction DR2.

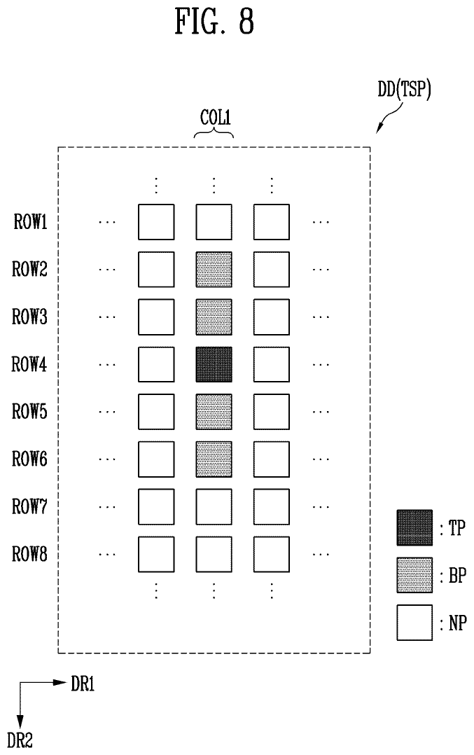

The circuit layer CIL may be disposed across the display area DA and the non-display area NDA, and may be disposed on the first base layer BS1. The circuit layer CIL may drive the pixel PXL and may include a pixel circuit electrically connected to the light-emitting element. The circuit layer CIL may include MUX transistors (refer to FIG. 8) forming the multiplexer MUX.

The light-emitting element layer LEL may be disposed on the circuit layer CIL in the display area DA. The light-emitting element layer LEL may include a light-emitting element that emits light. The light-emitting element may include an organic light emitting diode including an organic material, or may include an inorganic light emitting diode (for example, a micro-LED) including an inorganic material. However, the present disclosure is not limited thereto.

The encapsulation layer TFE may cover the light-emitting element layer LEL. At least a portion of the encapsulation layer TFE may be disposed in the display area DA. The encapsulation layer TFE may encapsulate the light-emitting element layer LEL.

The sensing unit TSP may be disposed across the sensing area SA and the non-sensing area NSA. At least a portion of the sensing unit TSP may be disposed (for example, directly disposed) on the encapsulation layer TFE.

In an embodiment, the sensing unit TSP may be formed on a separate substrate and then disposed on the encapsulation layer TFE without being combined with the display unit DP. Accordingly, the manufacturing process of the display device DD may be simplified.

FIG. 6 is a schematic diagram illustrating an operation in which the display device DD of FIG. 1 detects the touch input.

Referring to FIG. 6, the sensor driving unit SDV may obtain information on the user touch input UTI by using a self-capacitance method. In an embodiment, the panel PNL (or the sensing unit TSP) of FIG. 1 may include a capacitance electrode CE. In an embodiment, the capacitance electrode CE may be at least one of the electrodes of the display unit DP of FIG. 1. For example, the capacitance electrode CE may be a cathode electrode of the light-emitting element. However, the capacitance electrode CE is not necessarily limited thereto.

In an embodiment, the sensor driving unit SDV may charge and discharge electric charge to the sensing electrode SP through the signal line SGL, the multiplexer MUX, and the sensing line SL, and may detect a capacitance change of the sensing electrode SP to obtain information on the user touch input UTI. The information about the user touch input UTI may include the location of the user touch input UTI or the presence or absence of the user touch input UTI.

For example, a reference voltage (or the driving signal) provided by the sensor driving unit SDV may be applied to the sensing electrode SP, and when the user touch input UTI is applied, a self-capacitance Csf may be formed between the sensing electrode SP and the capacitance electrode CE, and the reference voltage may be changed to voltage information (or sensing signal) having a waveform changed by the self-capacitance Csf. The sensor driving unit SDV may receive the changed voltage information, and may analyze the changed voltage information to determine the position of the user touch input UTI, the presence or absence of the user touch input UTI, or the like.

The operation of the multiplexer MUX and the display device DD (or the sensing device) will be described with reference to FIGS. 7 to 9. For convenience of description, any content that may overlap with the foregoing shall not be briefly explained or repeated.

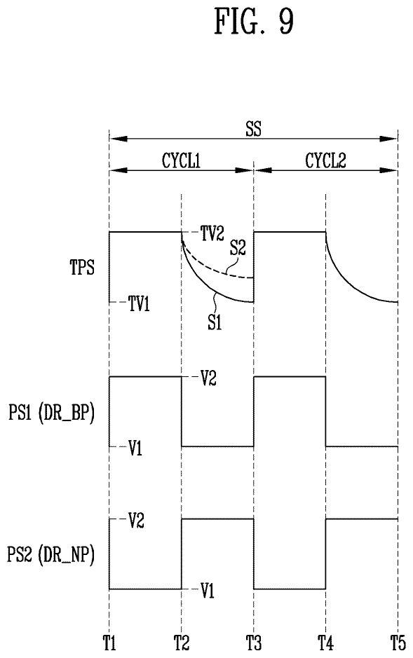

FIG. 7 is a schematic circuit diagram illustrating an embodiment of the multiplexer MUX included in the sensing unit TSP of FIG. 4. FIG. 8 is a plan view illustrating the operation of the sensing device. FIG. 9 is a waveform diagram illustrating an embodiment of a signal applied to the sensing electrode SP of FIG. 8.

Referring to FIG. 7, the multiplexer MUX may selectively connect the sensing line SL (or the sensing electrode SP) to the signal line SGL (or the touch sensing pad TPD), a first driving line DRL1, or a second driving line DRL2. A target pulse signal may be applied to the signal line SGL from the sensor driving unit SDV illustrated in FIG. 6, a first driving signal DR_NP may be applied to the first driving line DRL1, and a second driving signal DR_BP may be applied to the second driving line DRL2.

The multiplexer MUX may include a plurality of MUX transistors MT1 to MT4 (or transistors). For example, the first multiplexer MUX may include a first MUX transistor MT1 (or a first transistor) and a second MUX transistor MT2 (or a second transistor), and the second multiplexer MUX2 may include a third MUX transistor MT3 (or a third transistor) and a fourth MUX transistor MT4 (or a fourth transistor).

A first electrode of the first MUX transistor MT1 may be electrically connected to the sensing line SL, a second electrode of the first MUX transistor MT1 may be electrically connected to the first driving line DRL1, and a gate electrode of the first MUX transistor MT1 may be electrically connected to a first MUX gate line MGL1 (or a first gate line). The first MUX transistor MT1 may be turned on when a first gate signal MC_NP is applied from the first MUX gate line MGL1 to electrically connect the sensing line SL and the first driving line DRL1.

A first electrode of the second MUX transistor MT2 may be electrically connected to the sensing line SL, a second electrode of the second MUX transistor MT2 may be electrically connected to the connection line CL, and a gate electrode of the second MUX transistor MT2 may be electrically connected to a second MUX gate line MGL2 (or a second gate line). The second MUX transistor MT2 may be turned on when a second gate signal MC_SP is applied from the second MUX gate line MGL2 to electrically connect the sensing line SL and the connection line CL.

A first electrode of the third MUX transistor MT3 may be electrically connected to the connection line CL, a second electrode of the third MUX transistor MT3 may be electrically connected to the signal line SGL, and a gate electrode of the third MUX transistor MT3 may be electrically connected to a third MUX gate line MGL3 (or a third gate line). The third MUX transistor MT3 may be turned on when a third gate signal MC_S is applied from the third MUX gate line MGL3 to electrically connect the connection line CL and the signal line SGL.

A first electrode of the fourth MUX transistor MT4 may be electrically connected to the connection line CL, a second electrode of the fourth MUX transistor MT4 may be electrically connected to the second driving line DRL2, and a gate electrode of the fourth MUX transistor MT4 may be electrically connected to a fourth MUX gate line MGL4 (or a fourth gate line). The fourth MUX transistor MT4 may be turned on when a fourth gate signal MC_B is applied from the fourth MUX gate line MGL4 to electrically connect the connection line CL and the second driving line DRL2.

When the second MUX transistor MT2 and the third MUX transistor MT3 are turned on, the sensing line SL (or the sensing electrode SP) may be electrically connected to the signal line SGL (or the touch sensing pad TPD).

When the second MUX transistor MT2 and the fourth MUX transistor MT4 are turned on, the sensing line SL (or the sensing electrode SP) may be electrically connected to the second driving line DRL2, and the second driving signal DR_BP may be applied to the sensing electrode SP.

When the first MUX transistor MT1 is turned on, the sensing line SL (or the sensing electrode SP) may be electrically connected to the first driving line DRL1, and the first driving signal DR_NP may be applied to the sensing electrode SP.

The target pulse signal may be a sensing driving signal for sensing the user touch input UTI at a position where the sensing electrode SP (or a target sensing electrode TP (refer to FIG. 8)) electrically connected to the sensing line SL is disposed. The first driving signal DR_NP may be a sensing auxiliary signal applied to the corresponding sensing electrode SP (or the non-sensing electrode NP (refer to FIG. 8)) when the user touch input UTI is not sensed at or around the position where the sensing electrode SP electrically connected to the sensing line SL is disposed. The second driving signal DR_BP may be a sensing auxiliary signal for determining information about the user touch input UTI when sensing the user touch input UTI using another sensing electrode SP (or the adjacent sensing electrode BP (refer to FIG. 8)) in an area adjacent to a position where the sensing electrode SP electrically connected to the sensing line SL is disposed.

Referring to FIG. 8, with respect to the first sensor column COL1 included in the display device DD (or the sensing unit TSP), the sensing electrode disposed in a fourth row ROW4 may be selected as the target sensing electrode TP connected to the sensor driving unit SDV (refer to FIG. 6). In this case, a sensing electrode disposed in a row adjacent to the fourth row ROW4 may be an adjacent sensing electrode BP. For example, sensing electrodes disposed in a second row ROW2, a third row ROW3, a fifth row ROW5, and a sixth row ROW6 may be selected as the adjacent sensing electrodes BP. At least one of the sensing electrodes other than the sensing electrodes disposed in the second to sixth rows ROW2 to ROW6 may be a non-sensing electrode NP. For example, a sensing electrode disposed in a first row ROW1, a seventh row ROW7, and/or an eighth row ROW8 may be selected as the non-sensing electrode NP, but is not limited thereto.

For example, the first and second multiplexers MUX1 and MUX2 may electrically connect the sensing electrode disposed in the fourth row ROW4 to the touch sensing pad TPD, the second multiplexer MUX2 may electrically connect the sensing electrodes disposed in the second row ROW2, the third row ROW3, the fifth row ROW5, and the sixth row ROW6 to the second driving line DRL2, and the first multiplexer MUX1 may electrically connect the first row ROW1, the seventh row ROW7, and/or the eighth row ROW8 to the first driving line DRL1.

Referring to FIGS. 6 to 9, a target pulse signal TPS may be applied to the target sensing electrode TP from the sensor driving unit SDV. A first pulse signal PS1 may be applied to the adjacent sensing electrode BP. The first pulse signal PS1 may be the second driving signal DR_BP of the second driving line DRL2. A second pulse signal PS2 may be applied to the non-sensing electrode NP. The second pulse signal PS2 may be the first driving signal DR_NP of the first driving line DRL1. The first pulse signal PS1 may have the same phase as the target pulse signal TPS, and the second pulse signal PS2 may have a phase opposite to the target pulse signal PPS.

At a first time point T1, the target pulse signal TPS applied to the target sensing electrode TP may transition from a first target voltage level TV1 to a second target voltage level TV2.

At a second time point T2, the target pulse signal TPS may gradually decrease from the second target voltage level TV2 to the first target voltage level TV1. The slope of the voltage level of the target pulse signal TPS may change according to the user's touch. For example, when the user's touch is not adjacent to the target sensing electrode TP, the voltage level of the target pulse signal TPS may have a first slop S1. On the other hand, when the user's touch is adjacent to the target sensing electrode TP, the voltage level of the target pulse signal TPS may have a second slop S2. The sensor driving unit SDV (or processor) may sense the user's touch depending on whether the target pulse signal TPS has the first slop S1 or the second slop S2.

At the first time point T1, the first pulse signal PS1 applied to the adjacent sensing electrode BP may transition from the first voltage level V1 to the second voltage level V2. At the same time, the second pulse signal PS2 applied to the non-sensing electrode NP may transition from the second voltage level V2 to the first voltage level V1.

At the second time point T2, the first pulse signal PS1 may transition from the second voltage level V2 to the first voltage level V1. At the same time, the second pulse signal PS2 may transition from the first voltage level V1 to the second voltage level V2.

In addition, at a third time point T3, the first pulse signal PS1 may again transition from the first voltage level V1 to the second voltage level V2. At the same time, the second pulse signal PS2 may again transition from the second voltage level V2 to the first voltage level V1.

The time between the first and third time points T1 and T3 may be defined as a first period CYCL1. The operations at the third time point T3, a fourth time point T4, and a fifth time point T5 may be described in the same manner as the operations at the first time point T1, the second time point T2 and the third time point T3, respectively. At the fifth time point T5, a sensing period SS for the target sensing electrode TP ends, and the time period between the third and fifth time points T3 and T5 may be defined as a second period CYCL2 following the first period CYCL1. In this way, the sensing period SS may include one or more of the periods CYCL1 and CYCL2, so that the user's touch may be sensed through the target sensing electrode TP.

The first pulse signal PS1 applied to the adjacent sensing electrode BP may have a form in which a plurality of square waves are repeated during the sensing period SS, and the second pulse signal PS2 applied to the non-sensing electrode NP may have a form in which a plurality of square waves having a phase opposite to that of the first pulse signal PS1, are repeated. The first pulse signal PS1 and the second pulse signal PS2 may have the same frequency as the target pulse signal TPS. When the second pulse signal PS2 is applied to the non-sensing electrode NP, Electro Magnetic Interference (EMI) caused by the first pulse signal PS1 may be reduced and touch performance may be improved.

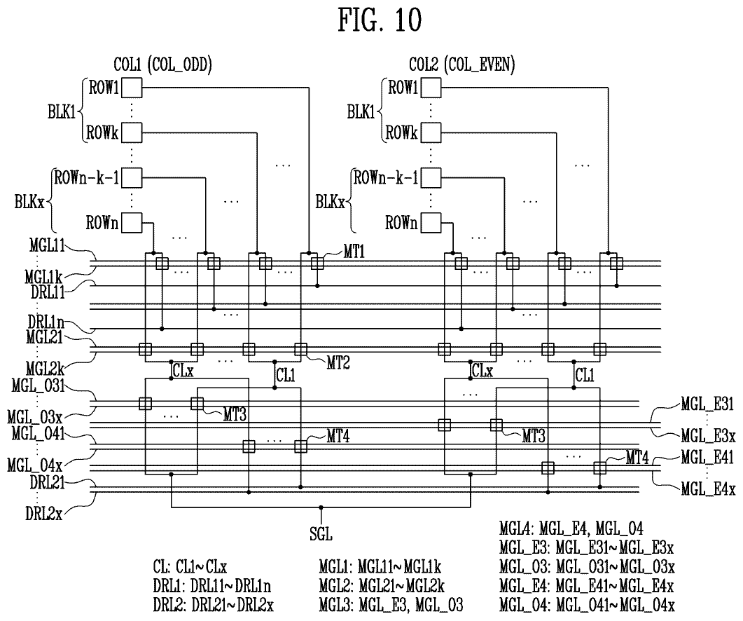

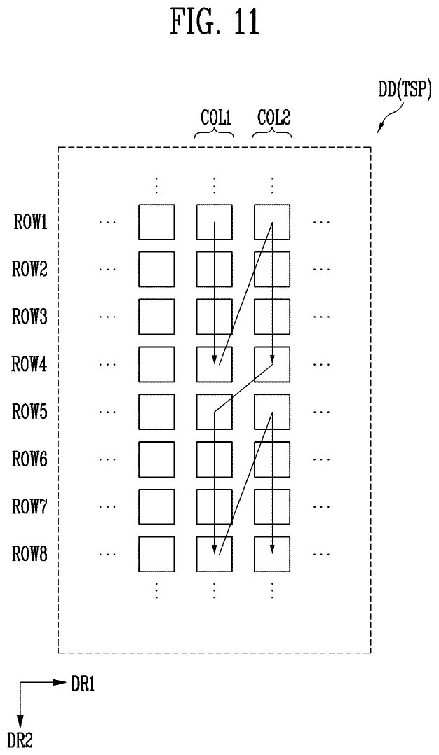

FIG. 10 is a schematic circuit diagram illustrating an embodiment of the sensing unit TSP of FIG. 4. FIG. 11 is a plan view illustrating the operation of the sensing unit TSP.

Referring to FIG. 4, FIG. 7, and FIG. 10, since the first sub-multiplexer MUX_S1 and the second sub-multiplexer MUX_S2 have substantially the same or similar circuit configurations, the sensing unit TSP will be described with a focus on the sensing electrode SP of the first sub-multiplexer MUX_S1 and the first area A1 connected thereto. In addition, for convenience of description, any content that may overlap with the foregoing shall not be briefly explained or repeated.

The first area A1 (or the second area A2) may include n rows ROW1 to ROWn. Accordingly, each of the first sensor column COL1 and the second sensor column COL2 may include n sensing electrodes SP, where n is a positive integer.

Hereinafter, the circuit configuration of the first sensor column COL1 will be explained first and then the circuit configuration of a second sensor column COL2 will be explained.

The k sensing electrodes SP may constitute one block, where k is a positive integer less than n. For example, a first block BLK1 may include sensing electrodes SP located in the first row ROW1 to the k-th row ROWk. The x-th block BLKx may include a sensing electrode SP located in the n−k−1-th row ROWn−k−1 to the n-th row ROWn, where x is a positive integer. That is, the k sensing electrodes SP may be divided into x blocks BLK1 to BLKx.

The first MUX transistor MT1 is provided corresponding to each of the rows ROW1 to ROWn, and the sensing electrode SP of the corresponding row may be electrically connected to the corresponding first driving line DLR1 in response to a signal of the corresponding first MUX gate line MGL1. For example, the first MUX transistor MT1 may electrically connect the sensing electrode SP of the first row ROW1 to an eleventh driving line DLR11 in response to a signal of an eleventh MUX gate line MGL11. For example, the first MUX transistor MT1 may electrically connect the sensing electrode SP of the first row ROWn to the 1n-th driving line DLR1n in response to a signal of the 1-kth MUX gate line MGL11. A plurality of first driving lines DRL11 to DRL1n may be provided corresponding to the rows ROW1 to ROWn so that the first driving signal DR_NP applied from the first driving line DRL1 to the rows ROW1 to ROWn is not affected by the turn-off of the plurality of first MUX transistors. For example, 24 first driving lines DRL11 to DRL1n may be provided corresponding to 24 rows ROW1 to ROWn (that is, where n is 24).

The second MUX transistor MT2 is provided corresponding to each of the rows ROW1 to ROWn, and the sensing electrode SP of the corresponding row may be electrically connected to the corresponding connection line CL in response to a signal of the corresponding second MUX gate line MGL2. For example, the second MUX transistor MT2 may electrically connect the sensing electrode SP of the first row ROW1 to the first connection line CL1 in response to the signal of a 21st MUX gate line MGL21. For example, the second MUX transistor MT2 may electrically connect the sensing electrode SP of the n-th row ROWn to the x-th connection line CLx in response to the signal of the 2k-th MUX gate line MGL2k.

The first multiplexer MUX1 (or the first sub-multiplexer MUX_S1) including the first MUX transistor MT1 and the second MUX transistor MT2 may electrically connect n sensing electrodes SP to x connection lines CL. That is, the first multiplexer MUX1 (or the first sub-multiplexer MUX_S1) may be an n/x:1 multiplexer.

The third MUX transistor MT3 is provided corresponding to each of the connection lines CL1 to CLx, and may electrically connect the connection lines CL1 to CLx to the signal line SGL in response to a signal of the corresponding a third odd MUX gate line MGL_O3. The third odd MUX gate line MGL_O3 may be the third MUX gate line for the first sensor column COL1 or the odd-numbered sensor column. For example, the third MUX transistor MT3 may electrically connect the first connection line CL1 to the signal line SGL in response to the signal of the 31st odd MUX gate line MGL_O31. For example, the third MUX transistor MT3 may electrically connect the x-th connection line CLx to the signal line SGL in response to the signal of the 3x odd MUX gate line MGL_O3x.

The fourth MUX transistor MT4 is provided corresponding to each of the connection lines CL1 to CLx, and the connection lines CL1 to CLx may be electrically connected to the second driving line DRL2 in response to a signal of the corresponding a fourth odd MUX gate line MGL_O4. The odd MUX gate line MGL_O4 may be the fourth MUX gate line MGL4 for the first sensor column COL1 or the odd-numbered sensor column. For example, the fourth MUX transistor MT4 may electrically connect the first connection line CL1 to the 21st driving line DRL21 in response to the signal of the 41st odd MUX gate line MGL_O 41. For example, the fourth MUX transistor MT4 may electrically connect the x-th connection line CLx to the 2x-th driving line DRL2x in response to the signal of the 4x-th odd MUX gate line MGL_O4x. Similar to the first driving lines DRL11 to DRL1n, the second driving lines DRL21 to DRL2x may be provided corresponding to the connection lines CL1 to CLx, respectively.

The number and connection configurations of the first and second MUX transistors MT1 and MT2 in the second sensor column COL2 may be substantially the same as the number and connection configurations of the first and the second MUX transistor MT1 and MT2 in the first sensor column COL1, respectively.

In the second sensor column COL2, the third MUX transistor MT3 is provided corresponding to each of the connection lines CL1 to CLx, and the connection lines CL1 to CLx may be electrically connected to the signal line SGL in response to the signal of the corresponding third even MUX gate line MGL_E3. The third even MUX gate line MGL_E3 may be the third MUX gate line for the second sensor column COL2 or the even-numbered sensor column MGL3. For example, the third MUX transistor MT3 may electrically connect the first connection line CL1 to the signal line SGL in response to the signal of the 31st even MUX gate line MGL_E 31. For example, the third MUX transistor MT3 may electrically connect the x-th connection line CLx to the signal line SGL in response to the signal of the third x-th even MUX gate line MGL_E3x.

In the second sensor column COL2, the fourth MUX transistor MT4 is provided corresponding to each of the connection lines CL1 to CLx, and the connection lines CL1 to CLx may be electrically connected to the second driving line DRL2 in response to the signal of the corresponding fourth even MUX gate line MGL_E4. The fourth even MUX gate line MGL_E4 may be the fourth MUX gate line for the second sensor column COL2 or the even-numbered sensor column MGL4. For example, the fourth MUX transistor MT4 may electrically connect the first connection line CL1 to the 21st driving line DRL21 in response to the signal of the 41st even MUX gate line MGL_E 41. For example, the fourth MUX transistor MT4 may electrically connect the x-th connection line CLx to the 2x-th driving line DRL2x in response to a signal from the 4x-th even MUX gate line MGL_E4x.

The second multiplexer MUX2 including the third MUX transistor MT3 and the fourth MUX transistor MT4 may electrically connect the x connection lines CL of the first sensor column COL1 and the x connection lines CL of the second sensor column COL2 to the signal line SGL. In other words, the second multiplexer MUX2 may be a 2x:1multiplexer.

The multiplexer MUX may selectively connect the sensing electrodes SP in the first sensor column COL1 and the second sensor column COL2 to the signal line SGL (or the touch sensing pad TPD).

In order to reduce the number of touch sensing pads TPD connected to the signal line SGL, the multiplexer MUX is configured such that the first sensor column COL1 and the second sensor column COL2 are connected to one signal line SGL, but the present inventive concept is not limited thereto. For example, the multiplexer MUX may be configured such that the first sensor column COL1 and the second sensor column COL2 are respectively connected to the two signal lines SGL.

In an embodiment, the multiplexer MUX may alternately select blocks of the first sensor column COL1 and blocks of the second sensor column COL1, and sequentially connect the sensing electrodes SP in the blocks to the touch sensing pads TPD.

Referring to FIG. 11, the first, second, third, and fourth rows ROW1, ROW2, ROW3, and ROW4 may be set as a first block, and the fifth, sixth, seventh, and eighth rows ROW5, ROW6, ROW7, and ROW8 may be set as a second block.

First, the first block of the first sensor column COL1 may be selected. For example, the third MUX transistor MT3 connected to the first connection line CL1 in the first pixel column COL1 of FIG. 10 may be turned on. In addition, the sensing electrodes SP of the first, second, third, and fourth rows ROW1, ROW2, ROW3, and ROW4 of the first sensor column COL1 may be sequentially selected as the target sensing electrodes. For example, the first MUX transistor MT1 connected to the first driving line DRL1 in the first pixel column COL1 of FIG. 10 may be sequentially turned on in the order from right to left.

Thereafter, the first block of the second sensor column COL2 may be selected. For example, the third MUX transistor MT3 connected to the first connection line CL1 in the second pixel column COL2 of FIG. 10 may be turned on. In addition, the sensing electrodes SP of the first, second, third, and fourth rows ROW1, ROW2, ROW3, and ROW4 of the second sensor column COL2 may be sequentially selected as the target sensing electrodes. For example, the first MUX transistor MT1 connected to the first driving line DRL1 in the second pixel column COL2 of FIG. 10 may be sequentially turned on in the order from right to left.

Thereafter, the second block of the first sensor column COL1 may be selected. For example, the third MUX transistor MT3 connected to the x-th connection line CLx in the first pixel column COL1 of FIG. 10 may be turned on. In addition, the sensing electrodes SP of the fifth, sixth, seventh, and eighth rows ROW5, ROW6, ROW7, and ROW8 of the first sensor column COL1 may be sequentially selected as the target sensing electrodes. For example, the first MUX transistor MT1 connected to the x-th driving line DRLn in the first pixel column COL1 of FIG. 10 may be sequentially turned on in the order from right to left.

Thereafter, the first block of the second sensor column COL2 may be selected. For example, the third MUX transistor MT3 connected to the first connection line CL1 in the second pixel column COL2 of FIG. 10 may be turned on. In addition, the sensing electrodes SP of the first, second, third, and fourth rows ROW1, ROW2, ROW3, and ROW4 of the second sensor column COL2 may be sequentially selected as the target sensing electrodes. For example, the first MUX transistor MT1 connected to the first driving line DRL1 in the second pixel column COL2 of FIG. 10 may be sequentially turned on in the order from right to left.

Thereafter, the second block of the second sensor column COL2 may be selected. For example, the third MUX transistor MT3 connected to the x-th connection line CLx in the second pixel column COL2 of FIG. 10 may be turned on. In addition, the sensing electrodes SP of the fifth, sixth, seventh, and eighth rows ROW5, ROW6, ROW7, and ROW8 of the second sensor column COL2 may be sequentially selected as the target sensing electrodes. For example, the first MUX transistor MT1 connected to the x-th driving line DRLx in the second pixel column COL2 of FIG. 10 may be sequentially turned on in the order from right to left.

However, the operation of the sensing unit TSP (or the display device DD) according to the embodiment of FIG. 11 is exemplary, and the operation of the sensor TSP is not limited thereto. For example, the sensing unit TSP may select the sensing electrodes SP of the second sensor column COL2 after selecting all the sensing electrodes SP of the first sensor column COL1. The sensing unit TSP may sequentially select the sensing electrodes SP of the two sensor columns COL1 and COL2 in various orders (or methods).

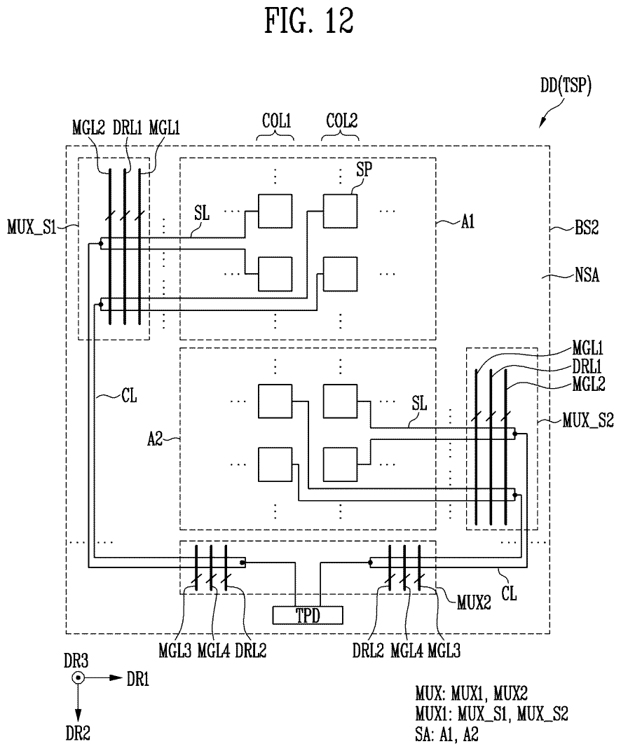

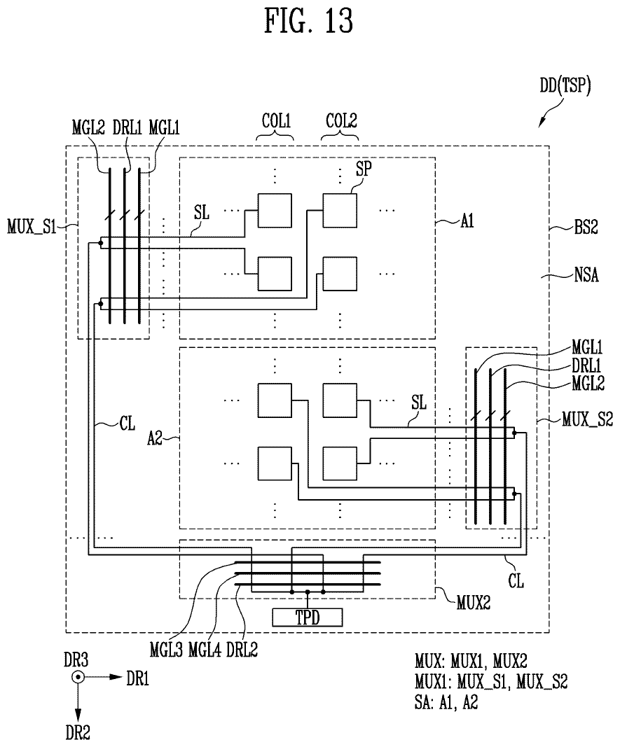

FIGS. 12 and 13 are schematic plan views illustrating an embodiment of the sensing unit TSP of FIG. 4.

Referring to FIGS. 4 and 12, the sensing unit TSP (or the display device DD) of FIG. 12 may be substantially the same as the sensing unit TSP of FIG. 4 except for the wires in the multiplexer MUX. Accordingly, the overlapping explanations shall not be repeated.

First wires may be arranged in an area in which the first sub-multiplexer MUX_S1 is arranged. The first wires may include the first driving line DRL1, the first MUX gate line MGL1, and the second MUX gate line MGL2. As described with reference to FIG. 10, the first driving line DRL1 may include the first driving lines DRL11 to DRL1n, the first MUX gate line MGL1 may include the first MUX gate lines MGL11 to MGL1k, and the second MUX gate line MGL2 may include the second MUX gate lines MGL21 to MGL2k. As described above, with respect to the first sensor column COL1 or the second sensor column COL2, the number of the first driving lines DRL11 to DRL1n connected to the first sub-multiplexer MUX_S1 may be equal to the number of the sensing electrodes SP arranged in the first area A1. The first MUX transistor MT1 and the second MUX transistor MT2 described with reference to FIG. 10 may be disposed in an area where the first sub-multiplexer MUX_S1 is disposed.

In an embodiment, in the area where the first sub-multiplexer MUX_S1 is disposed, the first driving line DRL1, the first MUX gate line MGL1, and the second MUX gate line MGL2 are disposed in the first direction DR1, and each of the first driving line DRL1, the first MUX gate line MGL1, and the second MUX gate line MGL2 may extend in the second direction DR2. For example, each of the first driving line DRL1, the first MUX gate line MGL1, and the second MUX gate line MGL2 extends along the one side of the sensing area SA, and may be connected to the pad disposed in the pad area PDA (refer to FIG. 3) or may be connected to an internal circuit provided in the non-sensing area NSA.

Similar to the first wires of the first sub-multiplexer MUX_S1, the second wires may also be arranged in an area in which the second sub-multiplexer MUX_S2 is arranged. The second wires may include the first driving line DRL1, the first MUX gate line MGL1, and the second MUX gate line MGL2. The second wires connected to the second sub-multiplexer MUX_S2 are for driving the sensing electrodes SP in the second area A2, the first wires connected to the first sub-multiplexer MUX_S1 are for driving the sensing electrodes SP in the first area A1, and the second wires connected to the second sub-multiplexer MUX_S2 may be provided separately from the first wires coupled to the first sub-multiplier MUX_S1. For example, the second lines connected to the second sub-multiplexer MUX_S2 and the first lines connected to the first sub-multiplexer MUX_S1 may be electrically insulated.

With respect to the entire sensing area SA, some of the wires connected to the first multiplexer MUX1 (that is, the first wires connected to the first sub-multiplexer MUX_S1 among the first and second wires) may be disposed on the one side of the sensing area SA, and the rest of the wires connected to the first multiplexer MUX1 may be disposed on the other side of the sensing areas SA (that is, the second wires connected to the second sub-multiplexer MUX_S2). Therefore, the width (or area) of the non-sensing area NSA located on the one side of the sensing area SA in the first direction DR1 may be reduced compared to a case where all the wires connected to the first multiplexer MUX1 are disposed on the one side of the sensing area SA.

Wires may be arranged in an area where the second multiplexer MUX2 is arranged. The wires may include the third MUX gate line MGL3, the fourth MUX gate line MGL4, and the second driving line DRL2. As described with reference to FIG. 10, the third MUX gate line MGL3 may include the third odd MUX gate lines MGL_O31 to MGL_ O3x and the third even MUX gate lines MGL_E31 to MGL_E3x, the fourth MUX gate line MGL4 may include the fourth odd MUX gate lines MGL_O41 to MGL_O4x and the fourth even MUX gate lines MGL_E41 to MGL_E4x, and the second driving line DRL2 may include the second driving lines DRL21 to DRL2x.

The wires (for example, the third wires) of the second multiplexer MUX2 for the first sub-multiplexer MUX_S1 may be disposed adjacent to the one side of the sensing area SA, and the wires (for example, the fourth wires) of the second multiplexer MUX2 for the second sub-multiplexer MUX_S2 may be disposed adjacent the other side of the sensing area SA.

In an embodiment, in the area where the second multiplexer MUX2 is disposed, the third MUX gate line MGL3, the fourth MUX gate line MGL4, and the second driving line DRL2 are arranged in the first direction DR1, and each of the third MUX gate line MGL3, the fourth MUX gate line MGL4, and the second driving line DRL2 may extend in the second direction DR2. For example, each of the third MUX gate line MGL3, the fourth MUX gate line MGL4, and the second driving line DRL2 extends in a direction perpendicular to the lower side of the sensing area SA, and may be connected to the pad disposed in the pad area PDA (refer to FIG. 3) or may be connected to the internal circuit provided in the non-sensing area NSA. When the number of wires of the second multiplexer MUX2 is greater than the number of connection lines CL, the width of the non-sensing area NSA in the second direction DR2 may be reduced by arranging the third MUX gate line MGL3, the fourth MUX gate line MGL4, and the second driving line DRL2 in the first direction DR1.

Referring to FIG. 13, in another embodiment, in the area where the second multiplexer MUX2 is disposed, the third MUX gate line MGL3, the fourth MUX gate line MGL4, and the second driving line DRL2 are disposed in the second direction DR2, and each of the third MUX gate line MGL3, the fourth MUX gate line MGL4, and the second driving line DRL2 may extend in the first direction DR1. When the number of wires of the second multiplexer MUX2 is less than the number of connection lines CL, the width of the non-sensing area NSA in the second direction DR2 may be reduced by arranging the third MUX gate line MGL3, the fourth MUX gate line MGL4, and the second driving line DRL2 in the second direction DR2.

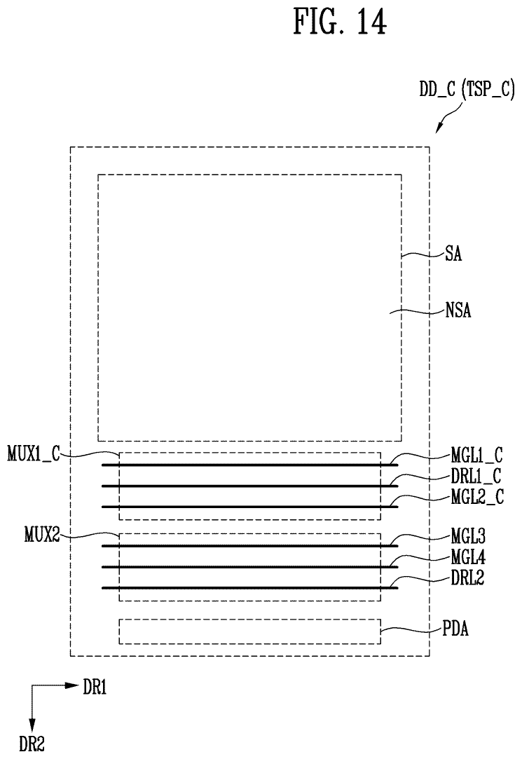

FIG. 14 is a schematic plan view illustrating a comparative example of a sensing unit TSP_C included in a display device DD_C.

Referring to FIG. 14, the display device DD_C or the sensing unit TSP_C may include a first multiplexer MUX1_C and the second multiplexer MUX2.

The first multiplexer MUX1_C and the second multiplexer MUX2 may be disposed in a lower direction of the sensing area SA. The first multiplexer MUX1_C and the second multiplexer MUX2 may be disposed between the sensing area SA and the pad area PDA.

A first MUX gate line MGL1_C, a first driving line DRL1_C, and a second MUX gate line MGL2_C may be arranged in an area where the first multiplexer MUX1_C is disposed. For example, the first MUX gate line MGL1_C, the first driving line DRL1_C, and the second MUX gate line MGL2_C are arranged in the second direction DR2, and each of the first MUX gate line MGL1_C, the first driving line DRL1_C and the second MUX gate line MGL2_C may extend in the first direction DR1.

As described with reference to FIG. 10, the first driving line DRL1_C may include the plurality of first driving lines, and the number of the plurality of first driving line may be equal to the number of sensing electrodes included in one sensor column. For example, when 48 sensing electrodes are included in one sensor column, the first driving line DRL1_C may include 48 first driving lines. For example, a space having a width of 4 mm or more in the second direction DR2 may be required to form the first multiplexer MUX1_C for driving the 48 sensing electrodes included in the one sensor column. In addition to the first multiplexer MUX1_C, the second multiplexer MUX2 and the pad area PDA are disposed in the non-sensing area NSA located in the lower direction of the sensing area SA, so the width of the non-sensing area NSA in the second direction DR2 may be 7 mm or more.

Therefore, in the sensing unit TSP (refer to FIG. 12) according to the embodiments of the present inventive concept, the width of the non-sensing area NSA in the second direction DR2 may be reduced by dispersing the first sub-multiplexer MUX_S1 and the second sub-multiplexers MUX_S2 on the one side and the other side of the sensing area SA different from the direction in which the second multiplexer MUX2 is disposed. For example, with respect to the case where the 48 sensing electrodes are included in the one sensor column, the width of the non-sensing area NSA in the second direction DR2 may be reduced to a level of 3 mm.

In addition, since the first sub-multiplexer MUX_S1 and the second sub-multiplexer MUX_S2 which respectively drive the sensing electrodes SP in the first area A1 and the second area A2 disposed along the second direction DR2, the number of the first driving lines DRL1 and the area for the first driving lines DRL1 may be reduced. For example, when the 48 sensing electrodes are included in the one sensor column, each of the first sub-multiplexer MUX_S1 and the second sub-multiplexer MUX_S2 is connected to 24 sensing electrodes, and the number of first driving lines DRL1 may be 24, which is half of the number of the first driving lines DRL1_C in FIG. 14 of the comparative example. Similar to the first driving line DRL1, the number of the first MUX gate lines MGL1 and the number of the second MUX gate lines MGL2 may also be reduced. Therefore, an increase in the width of the non-sensing area NSA located on the one side and the other side of the sensing area SA in the first direction DR1 may be minimized. In other words, the total area of the non-sensing area NSA may be minimized.

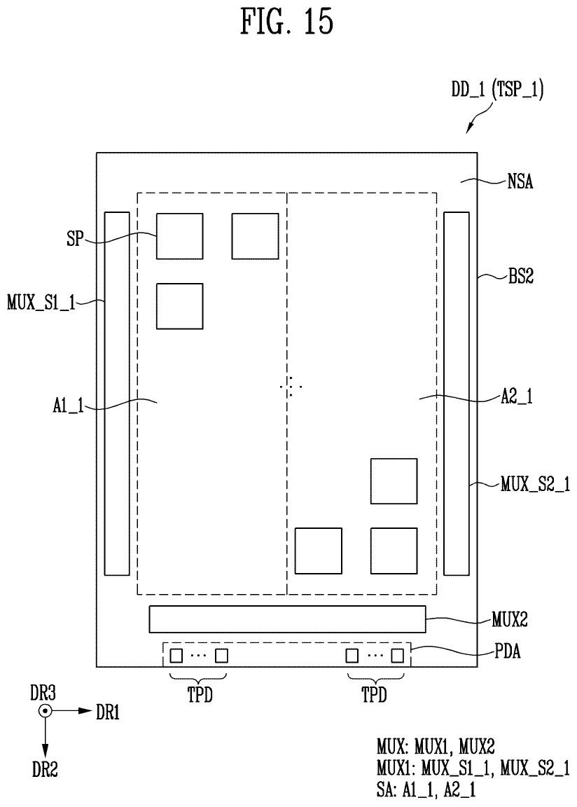

FIG. 15 is a schematic plan view illustrating an embodiment of the sensing unit TSP included in the display device DD of FIG. 1. For convenience of description, any content that may overlap with the foregoing shall be briefly explained or not be repeated.

Referring to FIG. 15, the first multiplexer MUX1 may include a first sub-multiplexer MUX_S1_1 and a second sub-multiplexer MUX_S2_1.

The first sub-multiplexer MUX_S1_1 may be disposed on one side of the sensing area SA, and the second sub-multiplexer MUX_S2_1 may be disposed on the other side of the sensing area SA. For example, the first sub-multiplexer MUX_S1_1 may be disposed on the left side of the sensing area SA, and the second sub-multiplexer MUX_S2_1 may be disposed on the right side of the sensing area SA.

The sensing area SA includes a first area A1_1 and a second area A2_2 arranged along the first direction DR1, the first sub-multiplexer MUX_S1_1 may be electrically connected to the sensing electrodes SP in the first area A1_1, and the second sub-multiplexer MUX_S2_1 may be electrically connected to the sensing electrodes SP in the second area A2. The first sub-multiplexer MUX_S1_1 may not be connected to or be electrically separated from the sensing electrodes SP in the second area A2_1, and the second sub-multiplexer MUX_S2_1 may not be connected to or be electrically separated from the sensing electrodes SP in the first area A1_1.

Since the first sub-multiplexer MUX_S1_1 is electrically connected to the sensing electrodes SP in the first area A1_1, the first sub-multiplexer MUX_S1_1 may be disposed substantially throughout the one side (for example, the left side) of the sensing area SA. Since the second sub-multiplexer MUX_S2_1 is electrically connected to the sensing electrodes SP in the second area A2_1, the second sub-multiplexer MUX_S2_1 may be disposed substantially throughout the other side (for example, the right side) of the second sub-multiplexer MUX_S2_1.

The width of the non-sensing area NSA in the second direction DR2 may be reduced by dispersing the first sub-multiplexer MUX_S1_1 and the second sub-multiplexer MUX_S2_1 on the one side and the other side of the sensing area SA different from the direction in which the second multiplexer MUX2 is disposed. For example, with respect to the case where the 48 sensing electrodes are included in the one sensor column, the width of the non-sensing area NSA in the second direction DR2 may be reduced to a level of 3 mm.

On the other hand, when the 48 sensing electrodes are included in the one sensor column, each of the first sub-multiplexer MUX_S1_1 and the second sub-multiplexer MUX_S2_1 is connected to the 48 sensing electrodes, and the number of wires connected to each of the first and second sub-multiplexers MUX_S1_1 and S2_1 is the same as the number of the wires connected to the first multiplexer MUX1_C in FIG. 14, and may be greater than the number of the wires connected to either the first or the second sub-multiplexer MUX_S1 or S2 in FIG. 12. The embodiment of FIG. 14 may be used when the number of rows is relatively small (for example, when the number of columns is less than the number of sensor columns).

The display device according to the embodiment may be applied to various electronic devices. The electronic device according to an embodiment includes the above-described display device, and may further include a module or device having an additional function other than the display device.

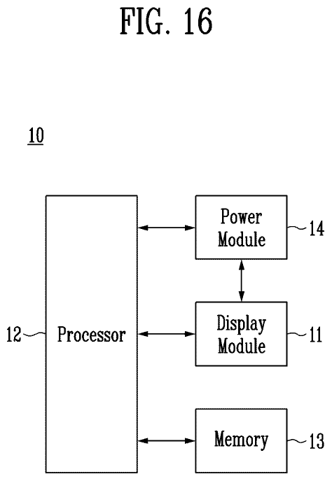

FIG. 16 is a block diagram of an electronic device 10 according to an embodiment. Referring to FIG. 16, the electronic device 10 according to an embodiment may include a display module 11 (or a display device), a processor 12, a memory 13, and a power module 14.

The processor 12 may include at least one of a central processing unit (CPU), an application processor (AP), a graphics processing unit (GPU), a communication processor (CP), an image signal processor (ISP), and a controller.

The memory 13 may store data information necessary for the operation of the processor 12 or the display module 11. When the processor 12 executes the application stored in the memory 13, the image data signal and/or the input control signal are transmitted to the display module 11, and the display module 11 may process the received signal and output the image information through the display screen.

The power supply module 14 (or power supply) may include a power supply module such as a power adapter or a battery device, and a power conversion module that converts power supplied by the power supply module to generate power necessary for the operation of the electronic device 10.

At least one of the above-described components of the electronic device 10 may be included in the display device according to the above-described embodiments. In addition, some of the individual modules that are functionally included in one module may be included in the display device, and others may be provided separately from the display device. For example, the display device includes the display module 11, and the processor 12, the memory 13, and the power module 14 may be provided in the form of other devices in the electronic device 10 other than the display device.

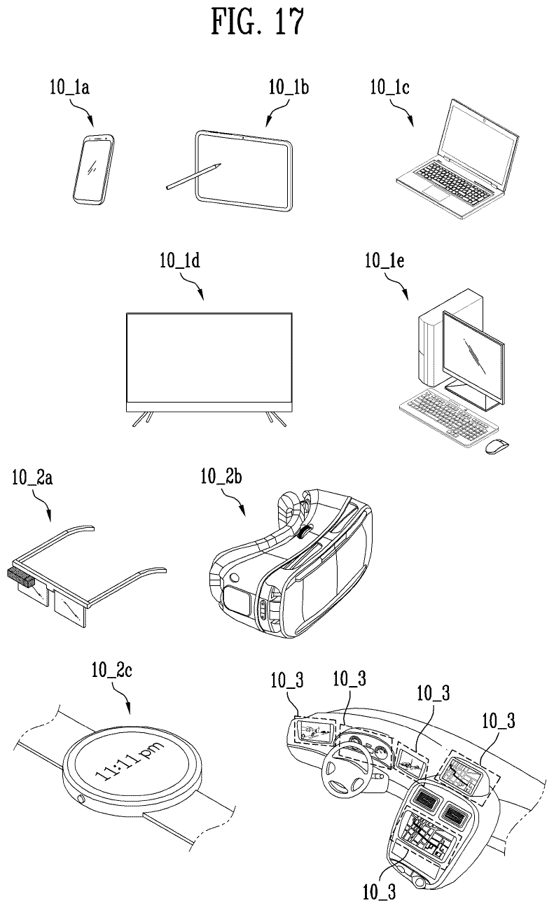

FIG. 17 is a schematic diagram of an electronic device according to various embodiments.

Referring to FIG. 17, various electronic devices to which a display device according to embodiments is applied may include not only an electronic device for displaying an image such as a smartphone 10_1a, a tablet PC 10_1b, a laptop 10_1c, a TV 10_1d, and a desk monitor 10_1e, but also a wearable electronic device including a display module such as smart glasses 10_2a, a head mounted display 10_2b, and a smart watch 10_2c, an electronic device for a vehicle 10_3 including a display module, such as a CID (Center Information Display) and a room mirror display, disposed on an instrument panel, a center fascia, and a dashboard of a vehicle, and the like.

It should be noted that, although the technical idea of the present inventive concept has been specifically described in accordance with the foregoing embodiments, the foregoing embodiments are for the purpose of description and not for the purpose of limitation. In addition, those skilled in the art may understand that various modifications are possible within the scope of the technical idea of the present inventive concept.

In a sensing device, a display device, and an electronic device according to the embodiments of the present inventive concept, a multiplexer connected between a sensing electrode and a pad may include a first sub-multiplexer, a second sub-multiplexer, and a second multiplexer, and the first sub-multiplexer, the second sub-multiplexer, and the second multiplexer may be distributed in different directions of a sensing area. Therefore, the average width of edges (or a dead space, a non-sensing area) may be minimized.

Effects according to embodiments are not limited to those illustrated above, and a wider variety of effects are included herein.

What is claimed is:

1. A sensing device comprising:
sensors arranged in a matrix form in a sensing area;
sensing lines electrically connected to the sensors, respectively; and
a first multiplexer electrically connected between the sensing lines and pads,
wherein the sensing area includes a first area and a second area,
wherein the first multiplexer includes:
a first sub-multiplexer electrically connected to the sensors in the first area; and
a second sub-multiplexer electrically connected to the sensors in the second area, and
wherein the first sub-multiplexer is disposed on one side of the sensing area and the second sub-multiplexer is disposed on another side of the sensing area.

2. The sensing device according to claim 1, wherein the first sub-multiplexer and the second sub-multiplexer are spaced apart from each other in a first direction with the sensing area interposed therebetween, and
wherein the first area and the second area are arranged along a second direction intersecting the first direction.

3. The sensing device according to claim 2, wherein the first sub-multiplexer is disposed on one side of the first area but not on one side of the second area, and
wherein the second sub-multiplexer is disposed on another side of the second area but not on another side the first area.

4. The sensing device according to claim 2, further comprising a second multiplexer electrically connected between the first multiplexer and the pads,
wherein the second multiplexer and the pads are arranged along the second direction from the sensing area.

5. The sensing device according to claim 4,
wherein the first multiplexer includes:
a first transistor electrically connected between one of the sensing lines and a first driving line; and
a second transistor electrically connected between the one sensing line and a connection line, and
wherein the second multiplexer includes:
a third transistor electrically connected between the connection line and one of the pads; and
a fourth transistor electrically connected between the connection line and a second driving line.

6. The sensing device according to claim 5,
wherein a target pulse signal is applied to the one pad,
wherein a first driving signal having a phase opposite to the target pulse signal is applied to the first driving line, and
wherein a second driving signal having the same phase as the target pulse signal is applied to the second driving line.

7. The sensing device according to claim 6, wherein,
with respect to the sensors disposed in one column:
the second multiplexer electrically connects a first sensor of the sensors to one of the pads and a second sensor adjacent to the first sensor to the second driving line; and
the first multiplexer electrically connects a third sensor of the sensors except for the first sensor and the second sensor to the first driving line.

8. The sensing device according to claim 5, further comprising a plurality of first driving lines respectively and electrically connected to the sensors arranged in one column through the first multiplexer,
wherein the plurality of first driving lines include the first driving line,
wherein a portion of the plurality of first driving lines are disposed on the one side of the sensing area and are electrically connected to the first sub-multiplexer, and
wherein a remaining portion of the plurality of first driving lines are disposed on the other side of the sensing area and are electrically connected to the second sub-multiplexer.

9. The sensing device according to claim 8, wherein,
with respect to the sensors disposed in one column:
a number of the portion of the plurality of first driving lines is equal to a number of the sensors arranged in the second direction in the first area, and
a number of the remaining portion of the plurality of first driving lines is equal to a number of the sensors arranged in the second direction in the second area.

10. The sensing device according to claim 8, wherein the plurality of first driving lines extend in the second direction in an area in which the first multiplexer is disposed.

11. The sensing device according to claim 10, wherein the second driving line extends in the second direction in an area in which the second multiplexer is disposed.

12. The sensing device according to claim 10, wherein the second driving line extends in the first direction in an area in which the second multiplexer is disposed.

13. The sensing device according to claim 1, wherein the first multiplexer selectively couples the sensors disposed in two columns to one of the pads.

14. The sensing device according to claim 1, wherein the first sub-multiplexer and the second sub-multiplexer are spaced apart from each other in a first direction with the sensing area interposed therebetween, and
wherein the first area and the second area are arranged along the first direction.

15. A display device comprising:
a display unit including a base layer and a light-emitting element disposed on the base layer;
a sensing unit disposed on the display unit and including sensors arranged in a matrix form in a sensing area and sensing lines electrically connected to the sensors, respectively; and
a first multiplexer electrically connected to the sensing lines,
wherein the sensing area includes a first area and a second area,
wherein the first multiplexer includes:
a first sub-multiplexer electrically connected to the sensors in the first area; and
a second sub-multiplexer electrically connected to the sensors in the second area, and
wherein the first sub-multiplexer is disposed on one side of the sensing area and the second sub-multiplexer is disposed on another side of the sensing area.

16. The display device according to claim 15, wherein the first sub-multiplexer and second sub-multiplexer are spaced apart from each other in a first direction with the sensing area interposed therebetween, and
wherein the first area and the second area are arranged along a second direction intersecting the first direction.

17. The display device according to claim 16, further comprising a second multiplexer electrically connected between the first multiplexer and the pads,
wherein the second multiplexer and the pads are arranged along the second direction from the sensing area.

18. The display device according to claim 17,
wherein the first multiplexer includes:
a first transistor electrically connected between one of the sensing lines and a first driving line; and
a second transistor electrically connected between the one sensing line and a connection line, and
wherein the second multiplexer includes:
a third transistor electrically connected between the connection line and one of the pads; and
a fourth transistor electrically connected between the connection line and a second driving line.

19. The display device according to claim 15, wherein the display unit includes a light-emitting element layer including a light-emitting device and an encapsulation layer disposed on the light-emitting element layer, and
wherein the sensing unit is disposed directly on the encapsulation layer.

20. An electronic device comprising:
a processor providing input image data;
a display device displaying an image based on the input image data; and
a power supply supplying power to the display device,
wherein the display device includes:
a display unit including a base layer and a light-emitting element disposed on the base layer;
a sensing unit disposed on the display unit and including sensors arranged in a matrix form in a sensing area and sensing lines electrically connected to the sensors, respectively; and
a first multiplexer electrically connected to the sensing lines,
wherein the sensing area includes a first area and a second area,
wherein the first multiplexer includes a first sub-multiplexer electrically connected to the sensors in the first area and a second sub-multiplexer electrically connected to the sensors in the second area, and
wherein the first sub-multiplexer is disposed on one side of the sensing area and the second sub-multiplexer is disposed on another side of the sensing area.
